(19) United States
(12) Patent Application Publication
(10) Pub. No.: US 2006/0127199 A1
(43) Pub. Date: Jun. 15, 2006

(54) Screwed insert

(75) Inventor: Adolf Bappert, Kappel (CH)

Correspondence Address: LADAS & PARRY, 26 WEST 61ST STREET, NEW YORK, NY, 10023, US

(73) Assignee: MUNGO BEFESTIGUNGSTECHNIK AG.

(21) Appl. No.: 11/293,936

(22) Filed: Dec. 5, 2005

(30) Foreign Application Priority Data
Dec. 10, 2004 (CH) 02062/04

(51) Int. Cl. F16B 35/04

(52) U.S. Cl. 411/411

(57) ABSTRACT

The screwed insert (1) has a shaft body (2) designed to receive a threaded fixing element and with an outer cutting thread (3) and a terminal flange (19), and ends in a pre-boring element (20). This pre-boring element includes one or more boring legs (21, 22) that extend parallel to each other and are unsupported at their ends, and of which the radially inner and outer adjacent surfaces form a continuation of the wall of the shaft body (2) and a longitudinally aligned cutting edge (23). Each of these cutting edges (23) terminates in an outer cutting tip (28,29). A centring tip (34) is provided at the free end of a radially inwardly directed continuation (35) of one of the boring legs (22) and is able to be pushed to one side when a long fixing element (1) is advanced. The screwed insert demonstrates good boring performance and anchoring for example in a drywall panel and provides a fixing element or the engaging shank thereof with an engagement length that extends beyond the shaft body (2) as far as the at least one boring leg (21,22) that is unsupported at its end.

The invention relates to a screwed insert with a shaft body that is designed to receive a threaded fixing element and is furnished with an outer cutting thread and a terminal flange, and a pre-boring element, which ends in two outer cutting tips and a centring tip.

Screwed inserts of this kind are known from U.S. Pat. No. 4,601,625 and U.S. Pat. No. 5,190,425. In the devices described in these documents, the pre-boring element is conformed centrally on the shaft body, e.g. in the manner of a spade or twist drill bit, in an attempt to obviate the need to pre-bore a locating hole for the shaft body in a separate work step. However, at a certain rotating speed when the screwed insert is set, when the cutting thread begins to bite, it causes axial movement of the screwed insert that is too fast for the drilling speed that is suitable for simultaneous pre-boring of a locating hole, with the result that the pre-boring element for these screwed inserts is almost the same length as the screw sleeve thereof, so that by the time the cutting thread of the shaft body begins to cut into the locating hole, the locating hole is already completed. This drawback is also described clearly with reference to a massive screw in U.S. Pat. No. 4,034,641.

Since the shaft body in these screwed inserts is centrally closed at the transition to the pre-boring element, a further disadvantage is created in that the length of the shaft body that is available for insertion of a fixing element is relatively small, so that only rather short fixing elements can be used. On the other hand, if the shaft body and thus also the pre-boring element are longer, there is a danger that the drilling tip will meet an obstruction behind a plasterboard surface, e.g. a concrete wall.

U.S. Pat. No. 4,601,625 therefore suggested a design including an attenuation point between the shaft body and the pre-boring element so that it is able to be bent aside upon contact with a threaded fixing element. However, when transferred to the screwed insert, the correspondingly large turning force that must be exerted on the fixing element to achieve this may destroy the engagement of screwed insert in the surrounding material, particularly in its typical use in drywall constructions.

From European Patent No. EP 0575295 it is further known to provide a fixing element with a considerably larger penetration depth for a predefined overall length of the screwed insert, without the need destroy or deflect the pre-boring element for this purpose. This was achieved with a short, conically tapered drilling tip like a milling cutter and the special conformation of the adjoining forward area of the screw sleeve with means for removing drill dust more easily. However, the short, relatively massive drilling tip makes it difficult if not impossible to drive a fixing element beyond the overall length of the screwed insert.

The object of the invention is to provide a screwed insert of the type described, which has good or improved boring effect but avoids the drawbacks indicated, thus providing maximum engagement length for a threaded fixing element relative to its overall length, and which assures good removal of drill dust and also allows penetration of a fixing element beyond the drilling tip without the need to apply significantly greater screwing force to the fixing element. This object is solved with the characterising features of claim 1. Advantageous embodiments of screwed inserts according to the invention are the object of the subordinate claims and may be understood from the following description with reference to the drawing.

In the drawing:

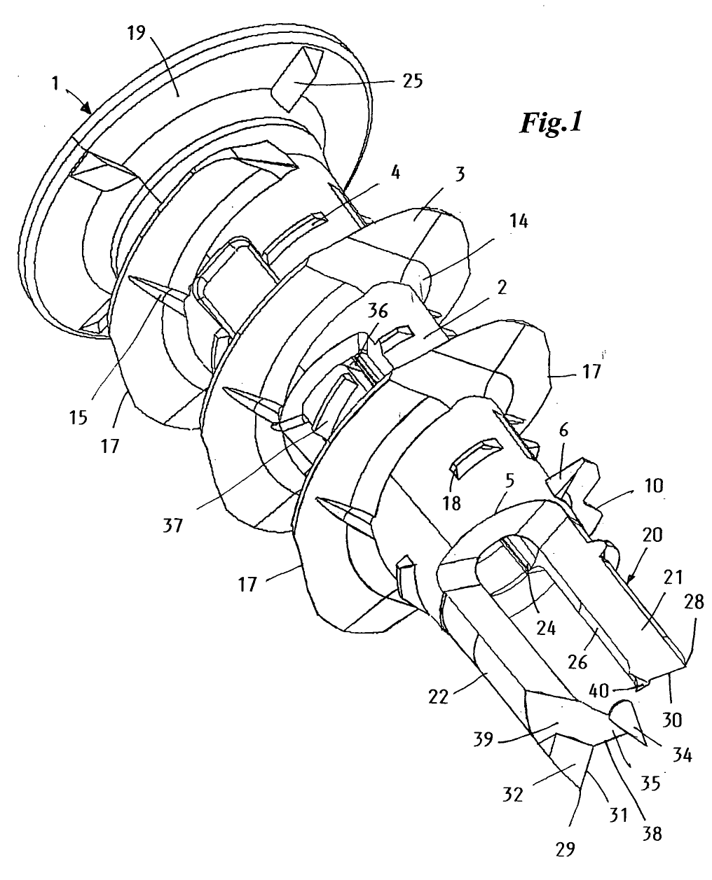

FIG. 1 is an enlarged perspective side view of a screwed insert according to the invention looking towards the underside of the terminal flange thereof,

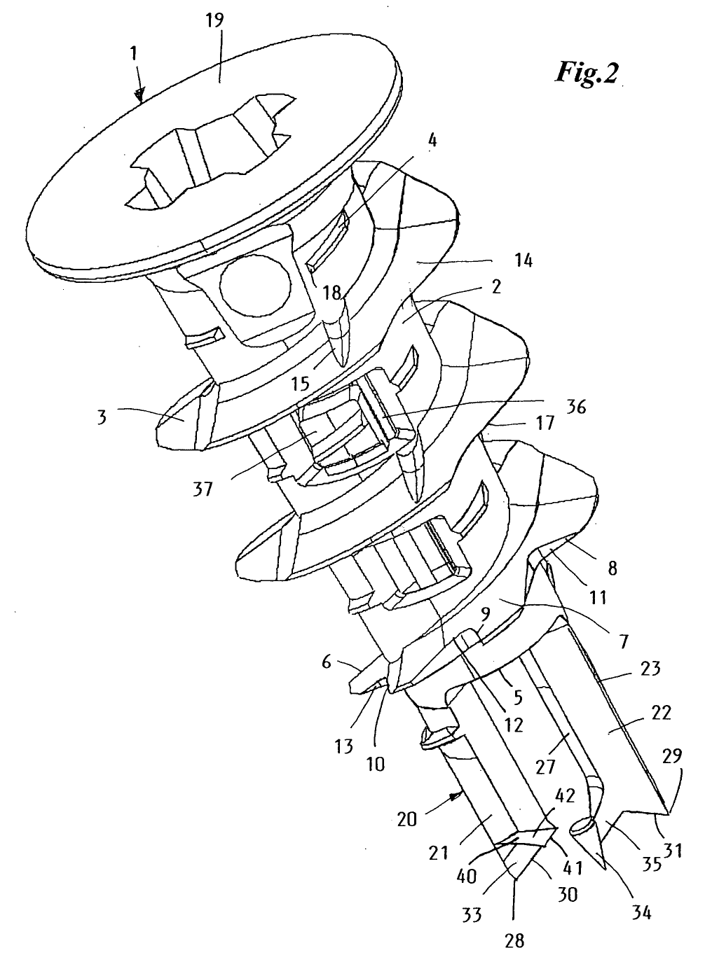

FIG. 2 is a perspective side view of a screwed insert according to FIG. 1 from a different angle and looking towards the upper side of the terminal flange thereof,

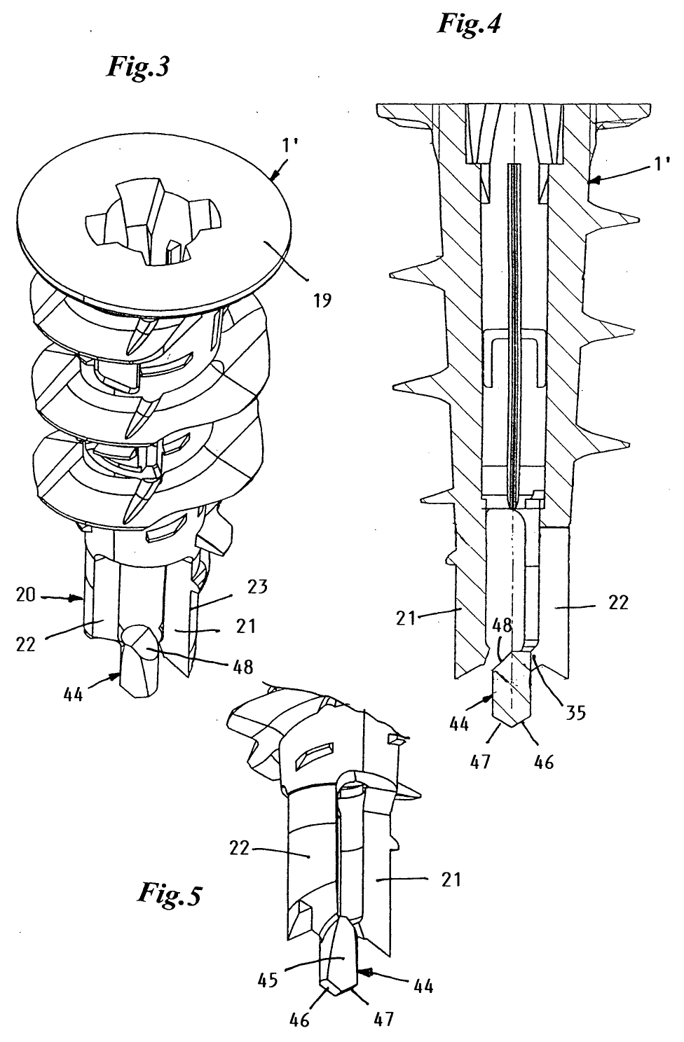

FIG. 3 is a perspective view of another embodiment of a screwed insert according to the invention,

FIG. 4 is an axial cross section of the screwed insert of FIG. 3 and

FIG. 5 is a perspective view of a front area of the screwed insert according to FIGS. 3 and 4 from a different viewing angle.

As shown in the embodiment of the drawing, a screwed insert 1 according to the invention has a preferably slightly conical shaft body 2 with an outer cutting thread 3, with which it is able to cut a matching engaging thread in surrounding material, such as a plasterboard panel, and a secondary thread 4 with a considerably smaller lead, running parallel therewith. Cutting thread 3 extends the entire length of shaft body 2 and ends at a shoulder close to the terminal edge 5 thereof, in such a way that it forms a leading cutting edge 6. The flank angle of thread 3 is relatively acute compared with that of normal wood screws and its lead angle is relatively small, so that screwed insert 1 achieves good anchoring particularly for fixtures in soft material, e.g. drywall panels.

One of the ways the cutting effect of cutting thread 3 may be improved is if its lead height is reduced at least along the length of the end area 7 thereof extending approximately 180° as far as cutting edge 6 and if it is also furnished in this end area 7 with ridges or interruptions 11,12,13 forming cutting edges 8,9,10. The flanks of cutting thread 3 also have flat protrusions 14 arranged one after the other along the circumference, and are furnished with ribs 15 that form cutting edges extending radially over the lead width. The cutting effect of cutting thread 3 is also further improved by an irregular course of its outer edge 16, which is produced for example by straight or inwardly curved sections 17, deviating from a circular arc course.

The secondary thread 4 running parallel to cutting thread 3 is also furnished with irregularities, with the effect that it extends around the shaft circumference in sections only, and each of its lead segments forms a cutting edge 18 that leads in the direction of rotation.

Cutting thread 3 thus has a multiple profile and for example has an external diameter that is twice as large as that of shaft body 2. In this way, good anchoring is also achieved in friable construction material such as gypsum, even though shaft body 2 may be relatively short.

A flange 19 is conformed on the rear end of the screwed insert, via which the screwed insert 1 is braced on the wall surface when it is screwed fully into a construction panel. Radial ribs 25 with a barbed cross-section are provided on the underside of flange 5 and enhance non-twisting anchoring of screwed insert 1 by engaging in a wall surface.

In order to enable screwed insert 1 to be anchored easily by screwing into a construction material such as a plasterboard panel, that is to say without the need to drill a hole in a separate work step, the leading part of shaft body 2 transitions into a boring element 20. In the embodiments shown, this is made up of two diametrically opposed boring legs 21,22, the long edges 23 of which form cutting edges because the lateral surfaces thereof that are leading in the cutting direction extend at least approximately radially inwards. The drill dust that is created may flow into the space between boring legs 21,22.

However, it is also possible to proved only one boring leg instead of two in the same configuration and arrangement as boring leg 22, or two further boring legs may be provided in addition to a boring leg 22 of this kind, so that a total of three are provided, which are designed to correspond with boring leg 21.

Boring legs 21,22 are preferably configured as ridgeless continuations of the wall of shaft body 2, and thus have the cross-sectional shape of a ring segment. In this way, the thread of a fixing element is able to cut not only into the interior wall or into longitudinal ribs 24 provided therein, but after penetrating the shaft body, boring leg 21,22 also encounters additional material on the interior wall 26,27 for further cutting into the screwed insert.

The free ends of both boring legs 21 and 22 terminate externally in a single tip 28,29, the outer leg of which forms a continuation of the cutting edges 23 of goring legs 21,22. Starting from the inner legs 30,31 of tip 28,29, the free ends of boring legs 21,22 are inclined over an inclined surface 32,33 in the trailing cutting direction, so that these inner legs 30,31 of tips 28,29 form a forward cutting edge. This shape of the free ends of boring legs 21,22 assures a clean starting cut when boring is begun, even if a drywall panel includes an outer paper layer for example. At the same time, the cutting edges may also be offset in the lengthwise direction of screwed insert 1 in the manner of teeth and may be conformed at different inclinations from their adjacent, trailing inclined surfaces 33 which serve to deflect chips, as is shown in the example of the internal, tooth-like extension 40 with cutting edge 41 and inclined surface 42.

The essential centring of pre-boring element 20, which also assures the precise positioning of screwed insert 1, is achieved via a centring tip 34, which may for example be conical, and which is conformed on an extension 35 of one of the boring legs 7,8 and is directed radially inwardly.

When a fixing element is introduced whose length does not match the length of screwed insert 1, such a centring tip 34 may be pushed to the side by the fixing element with little force, which means that there is no danger that the application of such force will damage or destroy the anchoring of the screwed insert in the surrounding material.

The radially inwardly directed continuation 35 of boring leg 22 preferably has an acutely angled cross section, with a leading cross-sectional edge, so that this serves as a cutting edge 38. At the same time, an inclined surface 39 of continuation 35 adjacent this cutting edge 38 forms a chip deflection surface 39, in the same way as the inclined surfaces 32,33 of the boring leg ends.

By virtue of the particularly good cutting performance of its edges (30,31,38, 23,41) and the large clearances for removing and collecting drill dust, the described configuration of pre-boring element 20 assures rapid advancement of screwed insert 1 in the wall material of a building with little application of force. This rapid penetration is also helped by the length of boring legs 21, 22, which are short relative to the length of shaft body 2, because the faster advance of screwed insert 1, which occurs when both secondary thread 4 and cutting thread 3 begin to bite, can be compensated by advancing the boring faster.

The screwed insert 1′ corresponding to the representations in FIGS. 3 to 5 differs from the screwed insert described previously in that the centring tip 44 has a chisel-like shape, because it has at least one lateral flattened area 45 and two leading cutting edges 46,47 directed towards each other at an oblique angle. An inclined surface 48 is provided on the free rear side thereof, which faces towards the interior of the insert, an a fixing element that is longer than screwed insert contacts this surface when it is inserted, so that centring tip 44 may be pressed aside more easily.

For the engagement of driving means to turn screwed insert 1, the insert is furnished with notches 16 arranged crosswise and inwardly adjacent longitudinal ribs of an engagement profile on the rear edge of shaft body 2.

A particularly suitable turning tool, which assures secure axial guidance when setting screwed insert 1 is known from German Patent No. DE 4439973. To enable bit tools with different profiles to be engaged, the longitudinal ribs of the engagement profile may be arranged with various distances from each other, as is known from European Patent No. EP 1298331.

To improve the anchoring of screwed insert 1 in the surrounding friable material, besides the outer cutting thread 3 hinge-like anchoring catches 37 may be retained in a wall orifice 36 of shaft body 2, projecting partially into the interior space of shaft body 2, so that that are forced outwards locally into the surrounding material when the fixing element is inserted.

For ease of manufacture in an injection moulding method, the screwed insert is made from a material suitable for such a process, such as zinc die-casting or a glass fibre laminate. The overall length thereof is for example 30 mm and the length of the boring legs 10 mm.

1. A screwed insert with a shaft body (2) that is designed to receive a threaded fixing element and is furnished with an outer cutting thread (3) and a terminal flange (19), and a pre-boring element (20), which ends in two outer cutting tips (28, 29) and a centring tip (34), characterized in that the pre-boring element (20) has at least one boring leg (21, 22) extending parallel to the axis of the shaft body (2) and with an unsupported end, and of which at least the outer radial contact surface forms a continuation of the curved, circular arc-shaped wall of the shaft body (2), wherein the centring tip (34) is provided on the free end of an inwardly directed extension (35) of the boring leg (22).

2. The screwed insert as cited in claim 1, characterized in that the at least one boring leg (21,22) forms a cutting edge (23) over the entire length thereof, which extends according to a continuation of a surface line of the shaft body (2), wherein the end area of cutting edge (23) forms a leg of a terminal cutting tip (28,29) and the inner leg (30,31) of the tip (28,29) becomes an inclined surface (32,33) of the boring leg (21,22) in the trailing cutting direction, so that the inner leg (30,31) of the tip (28,29) forms a leading cutting edge.

3. The screwed insert as cited in claim 1, characterized in that leading cutting edges (30,41) are offset relative to each other in the manner of teeth in the longitudinal direction of the screwed insert (1) and are conformed with a different angle of inclination than the trailing inclined surfaces (33,42) adjacent thereto, which serve as chip deflection surfaces.

4. The screwed insert as cited in claim 1, characterized in that the radially inwardly directed continuation (35) of the boring leg (22) has an acutely angled cross section, with a leading cross-sectional edge (38), so that this edge forms a cutting edge and is adjoined by a chip deflection surface (39).

5. The screwed insert as cited in claim 1, characterized in that two diametrically opposed boring legs (21,22) terminating in unattached manner are present.

6. The screwed insert as cited in claim 5, characterized in that the boring legs (21,22) are shorter than the shaft body (2), so that a thread section (7) of the shaft body (2) engages in the material before pre-boring is complete.

7. The screwed insert as cited in claim 6, characterized in that the length of the at least one boring leg (21,22) is equal to at least one third the overall length of the screwed insert (1).

8. The screwed insert as cited in claim 1, characterized in that the lead height of the cutting thread (3) is reduced towards the pre-boring element (20) and ends in a shoulder that forms a cutting edge (6) adjacent the pre-boring element.

9. The screwed insert as cited in claim 8, characterized in that the lead height of the cutting thread (3) is reduced over an arc length (7) of at least approximately 1800.

10. The screwed insert as cited in claim 1, characterized in that the cutting thread (3) is furnished with ridges (10-12) or interruptions forming cutting edges (8-10).

11. The screwed insert as cited in claim 1, characterized in that a secondary thread (4) with a low lead height is provided running parallel to the cutting thread (3), wherein it is made up of thread segments following each other with spaces therebetween, so that each thread segment has a leading cutting edge (18) in the direction of rotation.

12. The screwed insert as cited in claim 11, characterized in that the secondary thread (4) with a lower lead height than the cutting thread (3) extends part of the way along the length of the pre-boring element (20).

13. The screwed insert as cited in claim 1, characterized in that the drill tip (44) has at least one lateral flattened area (45) and two cutting edges (46,47) on the frontal face thereof extending at an angle to one another.

14. The screwed insert as cited in claim 13, characterized in that an inclined surface (48) is provided on the free rear side of drilling tip (44) and directed towards the interior of the insert.
